(19) United States
(12) Patent Application Publication
(10) Pub. No.: US 2021/0363319 A1
(43) Pub. Date: Nov. 25, 2021

(54) SILANE CROSSLINKABLE FOAMABLE POLYOLEFIN COMPOSITION AND FOAM

(71) Applicant: BOREALIS AG, Vienna (AT)

(72) Inventors: Tanja Piel, Linz (AT); Antti Tynys, Linz (AT); Stefan Hellström, Stenungsund (SE); Jeroen Oderkerk, Stenungsund (SE); Oscar Prieto, Stenungsund (SE); Jari-Jussi Ruskeeniemi, Kulloo (FI); Daniela Mileva, Linz (AT); Johan Defoer, Beringen (BE)

(21) Appl. No.: 17/286,670

(22) PCT Filed: Nov. 5, 2019
(86) PCT No.: PCT/EP2019/080252

§ 371 Date: Apr. 19, 2021

(30) Foreign Application Priority Data
Nov. 6, 2018 (EP) 18204565.8
Nov. 6, 2018 (EP) 18204587.2

(51) Int. Cl. C08J 9/12; C08L 23/08; C08J 9/00; C08K 3/34; C08K 5/42

(52) U.S. Cl. CPC C08J 9/122; C08L 2207/066; C08L 23/0815; C08J 9/0033; C08J 9/0066; C08K 3/34; C08K 5/42; C08J 2201/026; C08J 2201/03; C08J 2203/06; C08J 2203/08; C08J 2323/08; C08L 2203/14; C08L 2310/00; C08L 2312/08; C08L 23/0892

(57) ABSTRACT

The present invention is directed to a foamable polyolefin composition which is crosslinkable by silane groups, to a crosslinked foam obtained from such a foamable polyolefin composition, and to a process for producing a crosslinked foam based on the foamable polyolefin composition. The foamable polyolefin composition comprises a polyethylene bearing hydrolysable silane groups and comonomer units comprising a polar group selected from the group consisting of acrylic acid, methacrylic acid, acrylates, methacrylates, vinyl esters, and mixtures thereof, a silanol condensation catalyst, a physical blowing agent, and a cell nucleating agent.

The present invention is directed to a foamable polyolefin composition which is crosslinkable by silane groups, to a crosslinked foam obtained from such a foamable polyolefin composition, and to a process for producing a crosslinked foam based on a polyolefin composition which is crosslinkable by silane groups.

Soft, crosslinked foams are needed in several applications like in automotive (foam under the dashboard or door panel) and sporting goods (shoes or grips) as well as foamed sealings. Important for the above mentioned applications is a sufficient temperature resistance which is usually achieved by crosslinking the composition. Without crosslinking the foam could soften in the sun or otherwise at high temperatures and collapse.

Polyurethane (PU) foams are widely used in the above mentioned applications. PU foams are heat resistant, but many manufacturers would like to replace polyurethane foams with other alternatives, as chemicals used in making polyurethane are often toxic (iso-cyanate) and foaming is happening at the same time as polymerisation, usually in a mould.

Low density polyethylene (LDPE) is also widely used in foaming applications due to its branched structure. LDPE has excellent melt strength which allows foaming it to low densities. LDPE has excellent melt strength which allows foaming it to low densities. Compared to non-crosslinked polyethylene foam, cross-linked LDPE (XLPE) offers superior thermal stability as well as improved dimensional consistency and stability over a wide range of fabrication methods and end-user's conditions.

U.S. Pat. No. 5,844,009 discloses a cross-linked low-density polymer foam based on a blend of a low-density polyethylene resin (LDPE) and a silane-grafted polyolefin resin which is a copolymer of ethylene and a C₃ to C₂₀ alpha-olefin, and which polymerized in the presence of a single-site catalyst. The silanol condensation catalyst is a metal carboxylate like dibutyl tin dilaurate or dibutyl tin maleate.

U.S. Pat. No. 7,906,561 B2 discloses a cross-linked polyolefin foam based on a silane grafted polyethylene resin like a high melt strength low-density polyethylene. The silanol condensation catalyst is an organotin catalyst like dibutyl tin dilaurate.

A disadvantage of using non functionalised materials like LDPE, HDPE or elastomers is that they need to be functionalised (for example Si-grafted) prior to foaming to be able to cross-link the foam with for example a condensation catalyst. An alternative to this functionalization step is the application of an irradiation step for crosslinking the foam. In that case the crosslinking degree might be, however, limited. As can be derived from a document obtainable from the web page of BGS Beta-Gamma-Service GmbH & Co. KG, Wiehl, Germany (http://en.bgs.eu/wp-content/uploads/2017/02/BGS_radiation_crosslinking_en-1.pdf, page 12) a crosslinking degree of merely up to 75% can be reached in HDPE by irradiation. For certain properties like compression set, superior thermal stability, and low elongation at break, a higher cross-linking degree is needed.

There is accordingly still a need to provide an improved foamable polyolefin composition which is crosslinkable avoiding the disadvantages of the prior art.

Thus, one object of the present invention is to overcome the drawbacks of the state of the art and to provide a foamable polyolefin composition which is crosslinkable to obtain a still higher degree of crosslinking and which avoids the need of functionalization to enable crosslinking.

The present invention is based on the finding that the object can be solved by provision of a polyolefin composition comprising a polyethylene bearing hydrolysable silane groups. The polyethylene bearing hydrolysable silane groups is prepared by copolyerization of ethylene and a comonomer comprising a hydrolysable silane group thereby avoiding the need of an extra functionalization step. The polyolefin composition can be expanded and the silane groups crosslinked to obtain a crosslinked foam. This technology enables achieving rather high crosslinking degrees if desired.

Accordingly, the present invention is in a first aspect directed to a polyolefin composition comprising

(A) a polyethylene bearing hydrolysable silane groups,
(B) a silanol condensation catalyst,
(C) a blowing agent, and
(D) a cell nucleating agent,
wherein the polyethylene bearing hydrolysable silane groups (A) is a copolymer of ethylene and a comonomer comprising a hydrolysable silane group.

Furthermore, the polyethylene bearing hydrolysable silane groups according to the present invention further comprises comonomer units comprising a polar group, wherein the comonomer units comprising a polar group are obtained from a comonomer selected from the group consisting of acrylic acid, methacrylic acid, acrylates, methacrylates, vinyl esters, and mixtures thereof.

Still further, according to the present invention, the blowing agent (C) comprises a physical blowing agent or a mixture of physical blowing agents.

It is also known from literature (e.g. Klamper/Fisch; Polymeric foams; Hanser Publisher, 1991, chapter 9) that extruded polyolefin foams can be obtained either via chemical crosslinking or radiation crosslinking Both routes consist of the following steps:
mixing the polymers with
a) a chemical blowing agent in the case of radiation crosslinking or
b) a chemical blowing agent and a crosslinking agent, e.g. a peroxide or
extruding a sheet
in case of radiation crosslinking: crosslinking the extruded sheet
heating the sheet in an oven leading to:
1) decomposition of the peroxide in case of chemical crosslinking followed by the crosslinking of the polymer
2) decomposition of the chemical blowing agent leading to the foam.

Hence, to make a cross-linked LDPE (XLPE) foam there are two alternatives. The first one is where LDPE can be foamed first and cross-linked by irradiation. Cross-linking by irradiation needs a special laboratory with a bunker facility. There are only few such laboratories in Europe, which means that the foam need to be transported for cross-linking. The other alternative is to chemically cross-link the LDPE first and foam the cross-linked material. This process needs high temperatures and special lines.

WO 2006/048333 A1 discloses a method for producing crosslinked polyolefin foams via irradiation. The process consists of multiple steps: 1) blending a polymer with endothermic chemical blowing agents, 2) forming the blend into a sheet, 3) crosslinking the sheet by irradiation and 4) foaming the sheet. The irradiation can be done either by electron beam or gamma ray.

EP 0704476 A1 discloses a method for producing crosslinked polyolefin foams via irradiation. The process steps described are: 1) blending of polyolefin components, crosslinking agent, and chemical blowing agent, 2) extruding the resin composition to form a resin sheet, 3) exposing the sheet to an ionizing radiation source like electron beam radiation to form a cross-linked resin sheet and 4) foaming of the sheet in an oven.

GB 1126857 discloses a method for producing crosslinked polyolefin foams via chemical crosslinking. The process steps described are: 1) mixing polyolefin with organic peroxide and chemical blowing agent, wherein the chemical foaming agent has a decomposition temperature which is equal or higher than that of the organic peroxide, 2) shaping the resulting mixture into a sheet without decomposing the organic peroxide and blowing agent, 3) heating the sheet to crosslink the polyolefin sheet at its surface only and 4) heating the sheet to crosslink and foam the sheet.

U.S. Pat. No. 4,721,591 discloses a method for producing a crosslinked polyethylene foam having microcell structure via chemical crosslinking. The process steps described are: 1) mixing low density polyethylene, a chemical blowing agent having a decomposition temperature of at least 170° C., and a crosslinking initiator, 2) forming a sheet without substantially crosslinking and without substantially decomposing the blowing agent, 3) pre-heating the sheet to more than 80° C. but less than 110° C. for crosslinking and 4) heating the sheet to higher temperature for foaming.

Due to the currently used cumbersome production processes of crosslinked extruded polyethylene foams, there is still a need to provide a more simplified process for producing polyethylene-based foams.

Thus, another object of the present invention is to overcome the drawbacks of the state of the art and to provide a process for producing a crosslinked foam based on a polyolefin composition, wherein this process does neither need application of radiation nor application of heat in an oven, consumes less energy, does not require special productions lines or equipment, and consists of less process steps.

The present invention is also based on the finding that the object can be solved by provision of a process for producing a crosslinked foam based on a polyolefin composition which is crosslinkable by silane groups.

Accordingly, the present invention is in a second aspect directed to a process for producing a crosslinked foam comprising the following steps:
a) providing a polyolefin composition, wherein the polyolefin composition is as defined in connection with the first aspect of the present invention,
b) extruding the polyolefin composition through a die of an extruder,
c) allowing the extruded polyolefin composition to expand at ambient conditions, and
d) allowing the extruded polyolefin composition to crosslink at ambient conditions.

It should be noted that steps c) and d) may occur simultaneously, thus providing foaming and cross-linking in one single step.

As used herein, the term “at ambient conditions” denotes the normal atmospheric conditions of the ambient environment regarding temperature, pressure and humidity. This term does neither cover heating in an oven nor application of irradiation apart from naturally or artificially occurring light used for creation of visibility in working conditions of a human being.

A crosslinked foam is obtained from a polyolefin composition according to the process of the present invention.

The foam is obtained by foaming and crosslinking the polyolefin composition, i.e. the hydrolysable silane groups of the polyethylene bearing hydrolysable silane groups (A) are hydrolyzed and crosslinked. Foaming is established by extruding the polyolefin composition and expanding it to form a foam. Formation of the foam is achieved by expanding cells with a blowing agent (C), wherein the cells are nucleated by a cell nucleating agent (D). The step of crosslinking is catalyzed by a silanol condensation catalyst (B). First the hydrolysable silane groups are hydrolyzed in the presence of moisture to form silanol groups (—Si—OH). The silanol groups obtained accordingly condense to siloxane groups (—Si—O—Si—) thereby crosslinking the polyethylene.

Since hydrolysis of the silanol groups starts under the influence of moisture, crosslinking starts when the extrudate exits the die and is exposed to water naturally occurring in the ambient air. As an alternative, the foam may be treated in cold or hot water or a humidity tank after foaming. The foam may be used for sealing members, shoe soles, grips or roofing membranes.

There is no need of applying an additional step of grafting a polyethylene with hydrolysable silane groups.

### Polyethylene Bearing Hydrolysable Silane Groups (A)

As indicated above, the polyethylene bearing hydrolysable silane groups (A) according to the present invention is a copolymer of ethylene and a comonomer comprising a hydrolysable silane group.

As used herein, the term “copolymer of ethylene and a comonomer comprising a hydrolysable silane group” is directed to a copolymer which is obtained by polymerizing ethylene and a comonomer comprising a hydrolysable silane group.

As indicated above, the polyethylene bearing hydrolysable silane groups (A) comprises also comonomer units comprising a polar group.

Hence, the polyethylene bearing hydrolysable silane groups (A) is obtained by polymerizing ethylene, a comonomer comprising a hydrolysable silane group, and a comonomer comprising a polar group.

The comonomer units comprising a polar group are obtained from a comonomer selected from the group consisting of acrylic acid, methacrylic acid, acrylates, methacrylates, vinyl esters, and mixtures thereof.

Hence, the polyethylene bearing hydrolysable silane groups (A) is obtained by polymerizing ethylene, a comonomer comprising a hydrolysable silane group, and a comonomer comprising a polar group selected from the group consisting of acrylic acid, methacrylic acid, acrylates, methacrylates, vinyl esters, and mixtures thereof.

Hence, as used herein, the term “copolymer” covers also copolymers with more than one comonomer like a terpolymer of ethylene comprising apart from ethylene units and comonomer units comprising a hydrolysable silane group also a further comonomer unit, here a comonomer comprising a polar group, i.e. the copolymer is obtained by polymerizing ethylene, a comonomer comprising a hydrolysable silane group, a comonomer comprising a polar group, and optionally at least one further comonomer.

The acrylates are preferably alkyl acrylates, more preferably C₁ to C₆ alkyl acrylates, still more preferably C₁ to C₄ alkyl acrylates. The methacrylates are preferably alkyl methacrylates, more preferably C₁ to C₆ alkyl methacrylates, still more preferably C₁ to C₄ alkyl methacrylates. C₁ to C₄ alkyl covers methyl, ethyl, propyl and butyl. The vinyl ester is preferably vinyl acetate.

Preferably, the amount of the polyethylene bearing hydrolysable silane groups (A) is 20.0 to 98.0 wt % based on the weight of the polyolefin composition, like 30.0 to 98.0 wt % or 40.0 to 98.0 wt % or 50.0 to 98.0 wt % or 60.0 to 98.0 wt % or 70.0 to 98.0 wt % or 80.0 to 98.0 wt % or 85.0 to 95.0 wt %. Hence, the polyethylene bearing hydrolysable silane groups (A) may be mixed with a further polyolefin like low-density polyethylene or linear low-density polyethylene.

Preferably, the content of the hydrolysable silane groups is 0.2 to 4.0 wt % based on the weight of the polyethylene bearing hydrolysable silane groups (A).

Preferably, the polyethylene bearing hydrolysable silane groups (A) has a melt flow rate MFR₂ of 0.1 to 10 g/10 min, more preferably of 0.1 to 5.0 g/10 min.

According to a preferred embodiment of the present invention the comonomer comprising a hydrolysable silane group is represented by the following formula

R¹SiR²_{q}Y_{3-q} (I)

wherein R¹ is an ethylenically unsaturated hydrocarbyl, hydrocarbyloxy or (meth)acryloxy hydrocarbyl group,
each R² is independently an aliphatic saturated hydrocarbyl group,
Y, which may be the same or different, is a hydrolysable organic group and
q is 0, 1 or 2.

Special examples of this unsaturated silane compound according to formula (I) are those wherein R¹ is vinyl, allyl, isopropenyl, butenyl, cyclohexanyl or gamma-(meth)acryloxypropyl; wherein independently Y is methoxy, ethoxy, formyloxy, acetoxy, propionyloxy or an alkyl- or arylamino group; and R², if present, is a methyl, ethyl, propyl, decyl or phenyl group.

Further suitable silane compounds are e.g. gamma-(meth)acryloxypropyl trimethoxysilane, gamma(meth)acryloxypropyl triethoxysilane, and vinyl triacetoxysilane, or combinations of two or more thereof.

According to a preferred embodiment of the present invention the comonomer comprising a hydrolysable silane group is represented by the following formula

CH₂═CHSi(OA)₃ (II)

wherein A is a hydrocarbyl group having 1 to 8 carbon atoms, preferably 1 to 4 carbon atoms.

Preferred compounds are vinyl trimethoxysilane, vinyl bismethoxyethoxysilane, and vinyl triethoxysilane.

Preferably, the content of the comonomer units comprising a polar group is 2.0 to 35.0 wt % based on the weight of the polyethylene bearing hydrolysable silane groups (A).

The presence of the comonomer units comprising a polar group allows the modification of the softness of the polyolefin composition which property is then also transformed to the foam.

The polyethylene bearing hydrolysable silane groups (A) is an ethylene copolymer produced in the presence of an olefin polymerization catalyst or an ethylene copolymer produced in a high pressure process.

The term “olefin polymerization catalyst” means herein preferably a conventional coordination catalyst. It is preferably selected from a Ziegler-Natta catalyst, single site catalyst which term comprises a metallocene and a non-metallocene catalyst, or a chromium catalyst, or a vanadium catalyst or any mixture thereof. The terms have a well known meaning.

Polyethylene polymerized in the presence of an olefin polymerization catalyst in a low pressure process is also often called as “low pressure polyethylene” to distinguish it clearly from polyethylene produced in a high pressure process. Both expressions are well known in the polyolefin field. Low pressure polyethylene can be produced in polymerization process operating i.a. in bulk, slurry, solution, or gas phase conditions or in any combinations thereof. The olefin polymerization catalyst is typically a coordination catalyst.

Hence, the polyethylene bearing hydrolysable silane groups (A) can be a low pressure polyethylene (PE). Such low pressure PE is preferably selected from a very low density ethylene copolymer (VLDPE), a linear low density ethylene copolymer (LLDPE), a medium density ethylene copolymer (MDPE) or a high density ethylene copolymer (HDPE). These well known types are named according to their density area. The term VLDPE includes herein polyethylenes which are also known as plastomers and elastomers and covers the density range of from 850 to 909 kg/m³. The LLDPE has a density of from 909 to 930 kg/m³, preferably of from 910 to 929 kg/m³, more preferably of from 915 to 929 kg/m³. The MDPE has a density of from 930 to 945 kg/m³, preferably 931 to 945 kg/m³. The HDPE has a density of more than 945 kg/m³, preferably of more than 946 kg/m³, preferably form 946 to 977 kg/m³, more preferably form 946 to 965 kg/m³. Optionally, such low pressure copolymer of ethylene for the polyethylene bearing hydrolysable silane groups (A) is copolymerized with at least one further comonomer selected from C₃ to C₂₀ alpha-olefin, like from C₄ to C₁₂ alpha-olefin or from C₄ to C₈ alpha-olefin, e.g. with 1-butene, 1-hexene or 1-octene, or a mixture thereof.

Moreover, in case the polyethylene bearing hydrolysable silane groups (A) is a low pressure PE, then such PE can be unimodal or multimodal with respect to molecular weight distribution (MWD=M_{w}/Mₙ). Generally, a polymer comprising at least two polymer fractions, which have been produced under different polymerization conditions resulting in different (weight average) molecular weights and molecular weight distributions for the fractions, is referred to as “multimodal”. The prefix “multi” relates to the number of different polymer fractions present in the polymer. Thus, for example, multimodal polymer includes so called “bimodal” polymer consisting of two fractions.

The term “polymerization conditions” means herein any of process parameters, feeds and catalyst system.

Unimodal low pressure PE can be produced by a single stage polymerization in a single reactor in a well known and documented manner. Multimodal PE can be produced in one polymerization reactor by altering the polymerization conditions or in the multistage polymerization process which is conducted in at least two cascaded polymerization zones. Polymerization zones may be connected in parallel or the polymerization zones operate in cascaded mode. In a preferred multistage process a first polymerization step is carried out in at least one slurry, e.g. loop, reactor and the second polymerization step in one or more gas phase reactors. One preferable multistage process is described in EP 517 868.

Alternatively and preferably, the polyethylene bearing hydrolysable silane groups (A) can be a polyethylene which is produced in a high pressure polymerization (HP) process. In this embodiment the polyethylene bearing hydrolysable silane groups (A) is preferably produced in a high pressure polymerisation process in the presence of an initiator or initiators, more preferably is a low-density polyethylene (LDPE). It is to be noted that a polyethylene produced in a high pressure (HP) process is referred herein generally as LDPE and which term has a well known meaning in the polymer field. Although the term LDPE is an abbreviation for low-density polyethylene, the term is understood not to limit the density range, but covers the LDPE-like HP polyethylenes with low, medium and higher densities. The term LDPE describes and distinguishes only the nature of HP polyethylene with typical features, such as different branching architecture, compared to the PE produced in the presence of an olefin polymerisation catalyst.

In this embodiment the polyethylene bearing hydrolysable silane groups (A) is low-density copolymer of ethylene (referred herein as LDPE copolymer).

Optionally, such LDPE copolymer for the polyethylene bearing hydrolysable silane groups (A) is copolymerized with at least one further comonomer selected from C₃ to C₂₀ alpha-olefin, like from C₄ to C₁₂ alpha-olefin or from C₄ C₈ alpha-olefin, e.g. with 1-butene, 1-hexene or 1-octene, or a mixture thereof.

Accordingly, the LDPE copolymer for the polyethylene bearing hydrolysable silane groups (A) is preferably produced at high pressure by free radical initiated polymerisation (referred to as high pressure (HP) radical polymerization). The HP reactor can be e.g. a well known tubular or autoclave reactor or a mixture thereof, preferably a tubular reactor. The high pressure (HP) polymerisation and the adjustment of process conditions for further tailoring the other properties of the polyolefin depending on the desired end application are well known and described in the literature and can readily be used by a skilled person. Suitable polymerisation temperatures range up to 400° C., preferably from 80 to 350° C. and pressure from 70 MPa, preferably 100 to 400 MPa. More preferably from 100 to 350 MPa. Pressure can be measured at least after compression stage and/or after the tubular reactor. Temperature can be measured at several points during all steps.

The incorporation of the comonomer comprising a hydrolysable silane group and the comonomer comprising a polar group (as well as optional other comonomer(s)) and the control of the comonomer feed to obtain the desired final content of said hydrolysable silane group(s) containing units and comonomer units comprising a polar group can be carried out in a well known manner and is within the skills of a skilled person. Similarly, the MFR of the polymerized polymer can be controlled e.g. by a chain transfer agent, as well known in the field.

Further details of the production of ethylene copolymers by high pressure radical polymerization can be found i.a. in the Encyclopedia of Polymer Science and Engineering, vol. 6 (1986), 383-410 and Encyclopedia of Materials: Science and Technology, 2001 Elsevier Science Ltd: “Polyethylene: High-pressure, R. Klimesch, D. Littmann and F.-O. Mahling, 7181-7184.

### Silanol Condensation Catalyst (B)

Silanol condensation catalysts are known to the skilled person to catalyze the crosslinking reaction of hydrolysable silane groups to form siloxane groups. Silanol groups are obtained by hydrolysis of hydrolysable silane groups as in component (A) of the polyolefin composition of the present invention. The silanol groups subsequently condense to form siloxane groups.

Preferably, the amount of the silanol condensation catalyst (B) is 1.0 to 9.0 wt % based on the weight of the polyethylene bearing hydrolysable silane groups (A).

Several different silanol condensation catalysts are known like carboxylates of metals, such as tin, zinc, iron, lead and cobalt, organic bases, inorganic acids, and organic acids.

According to a preferred embodiment of the present invention the silanol condensation catalyst (B) comprises, more preferably consists of, an organic sulphonic acid or a precursor thereof including an acid anhydride thereof, or an organic sulphonic acid that has been provided with at least one hydrolysable protective group.

According to a more preferred embodiment of the present invention the silanol condensation catalyst (B) comprises, more preferably consists of, an aromatic organic sulphonic acid, which is preferably an organic sulphonic acid which comprises the structural element:

Ar(SO₃H)ₓ (III)

wherein Ar is an aryl group which may be substituted or non-substituted, and if substituted, then preferably with at least one hydrocarbyl group up to 50 carbon atoms, and x is at least 1; or a precursor of the sulphonic acid of formula (III) including an acid anhydride thereof or a sulphonic acid of formula (III) that has been provided with a hydrolysable protective group or hydrolysable protective groups, e.g. an acetyl group that is removable by hydrolysis.

Such organic sulphonic acids are described e. g. in EP 736065, or alternatively, in EP 1309631 and EP 1309632.

The preferred silanol condensation catalyst is an aromatic sulphonic acid, more preferably the aromatic organic sulphonic acid of formula (III). Said preferred sulphonic acid of formula (III) as the silanol condensation catalyst may comprise the structural unit according to formula (III) one or several times, e. g. two or three times (as a repeating unit (III)). For example, two structural units according to formula (III) may be linked to each other via a bridging group such as an alkylene group.

More preferably, the organic aromatic sulphonic acid of formula (III) as the preferred silanol condensation catalyst has from 6 to 200 carbon atoms, more preferably from 7 to 100 carbon atoms.

More preferably. in the sulphonic acid of formula (III) as the preferred silanol condensation catalyst, x is 1, 2 or 3, and more preferably x is 1 or 2. More preferably, in the sulphonic acid of formula (III) as the preferred silanol condensation catalyst, Ar is a phenyl group, a naphthalene group or an aromatic group comprising three fused rings such as phenantrene and anthracene.

Non-limiting examples of the even more preferable sulphonic acid compounds of formula (III) are p-toluene sulphonic acid, 1-naphtalene sulfonic acid, 2-naphtalene sulfonic acid, acetyl p-toluene sulfonate, acetylmethane-sulfonate, dodecyl benzene sulphonic acid, octadecanoyl-methanesulfonate and tetrapropyl benzene sulphonic acid; which each independently can be further substituted.

Even more preferred sulphonic acid of formula (III) is substituted, i.e. Ar is an aryl group which is substituted with at least one C₁ to C₃₀ hydrocarbyl group. In this more preferable subgroup of the sulphonic acid of formula (III), it is furthermore preferable that Ar is a phenyl group and x is at least one, more preferably x is 1, 2 or 3; and more preferably x is 1 or 2 and Ar is phenyl which is substituted with at least one C₃ to C₂₀ hydrocarbyl group. Most preferred sulphonic acid (III) as the silanol condensation catalyst is tetrapropyl benzene sulphonic acid and dodecyl benzene sulphonic acid, more preferably dodecyl benzene sulphonic acid.

### Blowing Agent (C)

Blowing agents, sometimes also called foaming agents, for producing foams are known to the skilled person. Blowing agents may be physical or chemical. Physical blowing agents are gases under the conditions at which expansion takes place, i.e. during the foaming step. Upon extrusion, the pressure surrounding the polyolefin composition drops and a physical blowing agent expands to form gas cells in the resin. Chemical blowing agents release a gas as consequence of a chemical reaction taking place.

As indicated above, the blowing agent (C) of the present invention comprises, more preferably consists of, a physical blowing agent or a mixture of physical blowing agents.

Preferably, the amount of the blowing agent (C) is 0.1 to 10 wt % based on the weight of the polyolefin composition.

Suitable physical blowing agents are low molecular weight hydrocarbons like C₁ to C₆ hydrocarbons such as acetylene, propane, propene, butane, butene, butadiene, isobutane, isobutylene, cyclobutane, cyclopropane, ethane, methane, ethene, pentane, pentene, cyclopentane, pentadiene, hexane, cyclohexane, hexene, and hexadiene, C₁ to C₅ organohalogens like 1,1-difluoroethane, C₁ to C₆ alcohols, C₁ to C₆ ethers, C₁ to C₅ esters, C₁ to C₅ amines, ammonia, nitrogen, carbon dioxide, neon, or helium.

In the process according to the present invention, the polyethylene bearing hydrolysable silane groups (A), the silanol condensation catalyst (B) and the cell nucleating agent (D) are blended prior to or during feeding into an extruder or the mixture is blended before. The physical blowing agent (C) is added as soon as the polymeric mixture is molten.

A physical blowing agent may be used in combination with a water releasing additive which release water at normal processing temperatures where foaming and crosslinking can occur simultaneously. Suitable water releasing additives are alumina trihydrate, hydrated calcium sulfate, and hydrotalcite.

A chemical blowing agent may be organic or inorganic. An organic blowing agent decomposes during melt processing to generate a gas resulting in subsequent foaming and may also generate an acidic compound and/or water on decomposition at foaming to promote moisture crosslinking of the silane groups. Suitable organic chemical blowing agents are azo compounds (azodicarbonamide, azohex-hydrobenzonitrile, diazoaminobenzene), nitroso compounds (N,N′-dinitroso-pentamethylenetetramine, N,N′-dinitroso-N,N′-dimethylphthalamide) and diazide compounds (terephthaldiazide, p-t-butylbenzazide). An inorganic chemical blowing agent is preferably used in combination with an organic acid in a masterbatch formulation. The organic acid used reacts with the inorganic chemical blowing agent generating a gas. Suitable inorganic chemical blowing agents are sodium bicarbonate, ammonium bicarbonate and ammonium carbonate. Suitable organic acids are citric acid, stearic acid, oleic acid, phthalic acid and maleic acid.

In case a chemical blowing agent is used in addition in the process according to the present invention, the polyethylene bearing hydrolysable silane groups (A), the silanol condensation catalyst (B), the chemical blowing agent, and the cell nucleating agent (D) are blended prior to or during feeding into an extruder. Decomposition of the chemical blowing agent to release a gas is effected at the elevated temperature in the extruder.

According to a particularly preferred embodiment of the present invention, the physical blowing agent or mixture of physical blowing agents comprises carbon dioxide, yet more preferably the blowing agent (C) consists of carbon dioxide.

### Cell Nucleating Agent (D)

Cell nucleating agents for producing foams are known to the skilled person. The cell nucleating agents act as nucleus for a cell which cell may be further expanded by a blowing agent to obtain a foam.

Chemical blowing agents as described above can be used as chemical nucleating agents if used in low amounts (˜0.3%). When chemical blowing agents are used to nucleate cell growth this is called active nucleation. On the other hand, if talc or some other inert particle (physical nucleating agent) is used as a nucleating agent, passive nucleation takes place.

Smaller cell size and accordingly higher cell density of foams are often desirable. Higher cell densities lead to foams of lower density. Higher cell densities can be achieved by the addition of a higher amount of cell nucleating agent to the polyolefin composition.

Preferably, the amount of the cell nucleating agent (D) is 0.1 to 5.0 wt % based on the weight of the polyolefin composition.

Preferably, the cell nucleating agent (D) is a physical nucleating agent.

Suitable cell nucleating agents are talc and calcium carbonate.

According to a preferred embodiment of the present invention the cell nucleating agent (D) is talc.

### Foam

The present invention is in a further aspect directed to a crosslinked foam obtained from a polyolefin composition according to the present invention including all preferred embodiments described above in connection with the first aspect directed to the polyolefin composition.

The foam according to the present invention is obtained by foaming and crosslinking the polyolefin composition, i.e. the hydrolysable silane groups of the polyethylene bearing hydrolysable silane groups (A) are hydrolyzed and crosslinked. Foaming is established by extruding the polyolefin composition and expanding it to form a foam. Formation of the foam is achieved by expanding cells with a blowing agent (C), wherein the cells are nucleated by a cell nucleating agent (D). The step of crosslinking is catalyzed by a silanol condensation catalyst (B). First the hydrolysable silane groups are hydrolyzed in the presence of moisture to form silanol groups (—Si—OH). The silanol groups obtained accordingly condense to siloxane groups (—Si—O—Si—) thereby crosslinking the polyethylene.

Since hydrolysis of the silanol groups starts under the influence of moisture, water may be directly added to the process as a source of moisture or water may be generated in the process by adding a water releasing additive (usually in combination with a physical blowing agent) or by decomposition of a suitable organic chemical blowing agent, or by reacting a suitable inorganic chemical blowing agent with an organic acid. Alternatively, the foam may be treated in hot water or a humidity tank after foaming.

According to present invention, crosslinking is preferably initiated by naturally occurring humidity of the ambient air.

The crosslinked foam according to the present invention obtained from a polyolefin composition according to the present invention contains immediately after the foaming step the blowing agent (physical blowing agent) or the gas released by decomposition of a blowing agent (chemical blowing agent). However, after a while the blowing agent or the gas released by decomposition of a blowing agent, respectively, might escape and be replaced by air. Hence, after a while a crosslinked foam according to the present invention may comprise the blowing agent or the gas released by decomposition of a blowing agent to a lesser extent. It may even be the case that replacement by the environmental air is such pronounced that no blowing agent or gas released by decomposition of a blowing agent is present in the foam anymore.

Therefore, the crosslinked foam obtained from a polyolefin composition according to the present invention covers foams which do not comprise any blowing agent anymore (physical blowing agent) or merely decompositions products thereof (chemical blowing agent).

The present invention is in a further aspect directed to a crosslinked foam comprising a polyethylene bearing siloxane groups (A′) obtained by crosslinking hydrolysable silane groups of a polyethylene bearing hydrolysable silane groups (A), the crosslinking reaction being catalyzed by a silanol condensation catalyst (B), and wherein the foam further comprises a cell nucleating agent (D), and optionally a blowing agent (C) or decomposition products thereof.

The polyethylene bearing hydrolysable silane groups (A), the silanol condensation catalyst (B), the blowing agent (C), and the cell nucleating agent (D) are the same as defined above in connection with the first aspect directed to the polyolefin composition, including all preferred embodiments.

### Use

The present invention is in a further aspect directed to the use of the polyolefin composition according to the present invention for producing a crosslinked foam. The foam may be used for sealing members, shoe soles, grips or roofing membranes.

In the following the present invention is further illustrated by means of examples.

### EXAMPLES

### 1. Definitions/Measuring Methods

The following definitions of terms and determination methods apply for the above general description of the invention as well as to the below examples unless otherwise defined.

### 1.1 Ethylene Content

Quantitative ¹³C {¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimised 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent {8}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {3, 4}. A total of 6144 (6 k) transients were acquired per spectra.

Quantitative ¹³C {¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed {7}.

The comonomer fraction was quantified using the method of Wang et. al. {6} through integration of multiple signals across the whole spectral region in the ¹³C {¹H} spectra. This method was chosen for its robust nature and ability to account for the presence of regiodefects when needed. Integral regions were slightly adjusted to increase applicability across the whole range of encountered comonomer contents. For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et al. {6}. Equations used for absolute propylene content were not modified.

The mole percent comonomer incorporation was calculated from the mole fraction:

E [mol %]=100*fE

The weight percent comonomer incorporation was calculated from the mole fraction:

E [wt %]=100*(fE*28.06)/((fE*28.06)+((1−fE)*42.08))

### BIBLIOGRAPHIC REFERENCES

1) Busico, V., Cipullo, R., Prog. Polym. Sci. 26 (2001) 443.
2) Busico, V., Cipullo, R., Monaco, G., Vacatello, M., Segre, A. L., Macromolecules 30 (1997) 6251.
3) Zhou, Z., Kuemmerle, R., Qiu, X., Redwine, D., Cong, R., Taha, A., Baugh, D. Winniford, B., J. Mag. Reson. 187 (2007) 225.
4) Busico, V., Carbonniere, P., Cipullo, R., Pellecchia, R., Severn, J., Talarico, G., Macromol. Rapid Commun. 2007, 28, 1128.
5) Resconi, L., Cavallo, L., Fait, A., Piemontesi, F., Chem. Rev. 2000, 100, 1253.
6) Wang, W-J., Zhu, S., Macromolecules 33 (2000), 1157.
7) Cheng, H. N., Macromolecules 17 (1984), 1950.
8) Singh, G., Kothari, A., Gupta, V., Polymer Testing 285 (2009), 475.
9) Kakugo, M., Naito, Y., Mizunuma, K., Miyatake, T. Macromolecules 15 (1982) 1150.
10) Randall, J. Macromol. Sci., Rev. Macromol. Chem. Phys. 1989, C29, 201.
11) Resconi, L., Cavallo, L., Fait, A., Piemontesi, F., Chem. Rev. 2000, 100, 1253.

### 1.2 Melt Flow Rate

Melt flow rate MFR₂ of polyethylene is determined according to ISO 1133 at 190° C. under a load of 2.16 kg.

### 1.3 Hardness

Hardness is determined by a Shore durometer according to DIN EN ISO 868.

### 1.4 Density

Density is measured according to ISO 1183-1—method A (2004). Sample preparation is done by compression moulding in accordance with ISO 1872-2:2007. Foam densities are measured according to ISO 854

### 1.5 Density Reduction

The density of the base resin is compared with the density of the foam. The reduction of density in percent is calculated.

### 1.6 Cell Density

For the determination of the mean cell size, the cross-sectional area of about 60 cells (if available) was measured. Therefor the cells were marked manually in the picture analysing software of the Alicona system. The mean diameters of the cells were calculated under the assumption that the bubbles have a circular cross section. This method helps to compare the foam morphologies of the different samples, because the geometry of most of the cells differs from the ideal round shape and so a reasonable comparison of direct measured diameters is not possible.

By using equation 1 and subsequently averaging the calculated values of each bubble diameter the mean diameter was determined.

$${D}_{z , kreis} = \sqrt{\frac{4 {A}_{z}}{π}} \qquad ( 1 )$$

### Using:

D_{z,kreis}=diameter of one foam cell under the assumption of a circular cross section in μm
A_{z}=cross section of one foam bubble in μm²

### 1.7 Average Cell Size

To calculate the cell density, the cell diameter, and the density the following equation is needed.

$${N}_{b} = \frac{1 - \frac{{ρ}_{F}}{{ρ}_{m}}}{\frac{π}{6} {D}^{3}} \qquad ( 3 )$$

### With:

ρF=density of the foamed specimen in g/cm³
ρm=density of the polymer matrix

### 1.8 Crosslinking Degree (XHU)

Degree of crosslinking was measured by decaline extraction (Measured according to ASTM D 2765-01, Method A) on the crosslinked material.

### 1.9 Si Content and Content of the Hydrolysable Silane Groups

The amount of hydrolysable silane groups (SiR²_{q}Y_{3-q}) was determined using X-ray fluorescence analysis. The pellet sample was pressed to a 3 mm thick plaque (150° C. for 2 minutes, under pressure of 5 bar and cooled to room temperature). Si-atom content was analysed by wavelength dispersive XRF (AXS S4 Pioneer Sequential X-ray Spectrometer supplied by Bruker). Generally, in XRF-method. the sample is irradiated by electromagnetic waves with wavelengths 0.01-10 nm. The elements present in the sample will then emit fluorescent X-ray radiation with discrete energies that are characteristic for each element. By measuring the intensities of the emitted energies, quantitative analysis can be performed. The quantitative methods are calibrated with compounds with known concentrations of the element of interest e.g. prepared in a Brabender compounder. The XRF results show the total content (wt %) of Si and are then calculated and expressed as content (wt %) of hydrolysable silane groups based on the weight of the polyethylene bearing hydrolysable silane groups.

### 2. Examples

The following materials and compounds are used in the Examples.
LDPE Low density polyethylene having an MFR₂ (190° C., 2.16 kg) of 0.75 g/10 min, a density of 923 kg/m³, and a hardness Shore D of 52, commercially available as FT5230 from Borealis AG Austria
LDPE-Si-1 Low density polyethylene which is copolymerized with vinyl silane having an MFR₂ (190° C., 2.16 kg) of 1.0 g/10 min, a density of 923 kg/m³, and a hardness Shore D of 52, commercially available as Visico™ LE4423 from Borealis AG Austria
LDPE-Si-2 Low density polyethylene which is copolymerized with vinyl silane having an MFR₂ (190° C., 2.16 kg) of 2.0 g/10 min, a density of 948 kg/m³, and a hardness Shore A of 63, commercially available as LE8824E from Borealis AG Austria
Plastomer Copolymer of ethylene and 1-octene, commercially available as Queo 6201 from Borealis AG Austria
Cat Silanol condensation catalyst masterbatch comprising organic sulphonic acid, commercially available as Ambicat™ LE4476 from Borealis AG Austria
CO₂ Supercritical carbon dioxide
Talc-MB Masterbatch containing 50 wt % talc and 50 wt % LDPE

The recipes of the compositions of inventive and comparative examples are indicated in Table 1 below. The respective polyethylene (bearing hydrolysable silane groups or not) is the so-called base resin.

TABLE 1
Compositions of Examples

| | | Si-content of | | | |
|---|---|---|---|---|---|
| | | base resin/ | Talc-MB/ | Cat/ | CO₂/ |
| | Base resin | wt % | wt % | wt % | wt % |
| CE1 | LDPE | 0 | — | — | 0.5 |
| CE2 | LDPE | 0 | 2.0 | — | 0.5 |
| CE3 | LDPE-Si-1 | 1.1 | 2.0 | — | 0.5 |
| CE4 | LDPE-Si-2 | 1.8 | 2.0 | — | 0.35 |
| IE1 | LDPE-Si-1 | 1.1 | 2.0 | 5.0 | 0.5 |
| IE2 | LDPE-Si-1 | 1.1 | 2.0 | 5.0 | 0.7 |
| IE3 | LDPE-Si-1 | 1.1 | 2.0 | 5.0 | 0.3 |
| IE4 | LDPE-Si-2 | 1.8 | 2.0 | 5.0 | 0.35 |
| IE5 | LDPE-Si-2 | 1.8 | 2.0 | 5.0 | 0.5 |

The compositions of these comparative and inventive examples were prepared as follows.

The grooved single screw extrusion line Rosendahl RE45 (Rosendahl Maschinen GmbH, Austria) equipped with a screw of 45 mm diameter was used. The extruder has a total length of 32 D, including an 8 D long, oil tempered cylinder elongation used for a better control of the polymer melt temperature. To realize a higher dwell time and a better homogenization a static mixer, type SMB-R (Sulzer, Switzerland) with a length of 4 D is mounted between the cylinder elongation and the extrusion die. Round die inserts was used having a diameter of 2.5 mm.

Table 2 shows process parameters, while Table 3 illustrates the temperature profile.

TABLE 2
Process parameters and injected gas amount
of the different material formulations

| | Screw speed/ | Mass flow/ | Gas amount/ | Gas pressure/ |
|---|---|---|---|---|
| | rpm | kg/h | ml/min | bar |
| CE1 | 10 | 4.4 | 0.46 | 119 |
| CE2 | 10 | 4.4 | 0.46 | 119 |
| CE3 | 10 | 4.3 | 0.47 | 113 |
| CE4 | 25 | 6.3 | 0.52 | 80 |
| IE1 | 10 | 4.3 | 0.48 | 106 |
| IE2 | 10 | 4.3 | 0.67 | 104 |
| IE3 | 10 | 4.3 | 0.28 | 105 |
| IE4 | 20 | 5.2 | 0.39 | 76 |
| IE5 | 20 | 5.2 | 0.57 | 79 |

Due to the different material behaviour and the resulting pressure profiles, it was necessary to variate the extrusion speed for the different formulations. In consideration of changing process parameters (pressure and mass flow) during the extrusion of different material formulations, the amount of CO₂ (in ml per minute) has to be adapted to ensure a constant and correct dosage of the blowing agent for all samples.

To guarantee constant parameters and reproducible samples the process has to run for a certain time until stationary conditions set in. Then the mass flow was determined, the required volume of CO₂ is calculated and set at the syringe pump. After stationary conditions have set in, again three samples for a later characterization of the foam morphology were taken.

TABLE 3
Temperature profile in extruder (values in degree centigrade)

| Base resin | T1 | T2 | T3 | T4 | T5 | T6 | T7 | T8 | T9 | T10 | T11 | T12 | Die |
|---|---|---|---|---|---|---|---|---|---|---|---|---|---|
| LDPE | 40 | 140 | 160 | 170 | 180 | 190 | 200 | 200 | 200 | 200 | 200 | 200 | 200 |
| LDPE-Si-1 | 40 | 140 | 160 | 170 | 180 | 190 | 200 | 200 | 200 | 200 | 200 | 200 | 200 |
| LDPE-Si-2 | 20 | 120 | 145 | 155 | 170 | 180 | 190 | 190 | 190 | 190 | 190 | 190 | 190 |

The resulting properties of the foams obtained from the polyolefin compositions are indicated in Table 4 below.

TABLE 4
Properties of Foams

| | | Average | | | |
|---|---|---|---|---|---|
| | Foam density/ | cell | Cell density/ | Density | XHU/ |
| | kg/m³ | size/μm | Nb/cm³ | reduction/% | wt % |
| CE1 | 298 | 1705 | 261 | 67.7 | 0 |
| CE2 | 266 | 515 | 9980 | 71.2 | 0 |
| CE3 | 252 | 295 | 53800 | 72.7 | <0.1 |
| CE4 | 370 | 238 | 86500 | 61.0 | 0.28 |
| IE1 | 217 | 313 | 47500 | 76.5 | 97 |
| IE2 | 251 | 328 | 39200 | 72.8 | n.d. |
| IE3 | 398 | 293 | 43100 | 56.8 | n.d. |
| IE4 | 384 | 244 | 78400 | 59.5 | 97 |
| IE5 | 405 | 246 | 73800 | 57.3 | n.d. |

n.d.: not determined

As can be derived from Table 4 above, the polyolefin compositions according to the present invention enable producing crosslinked foams with high degree of crosslinking XHU.

The recipes of the compositions of further inventive and comparative examples are indicated in Table 5 below. The respective polyethylene (bearing hydrolysable silane groups or not) is the so-called base resin. Table 5 does also indicate the extruder settings and the temperature profiles. The resulting properties of the foams obtained from the polyolefin compositions are indicated in Table 6 below.

TABLE 5
Compositions of Examples, Extruder
Settings, and Temperature Profiles

| | | CE5 | CE6 | IE6 | IE7 | CE7 |
|---|---|---|---|---|---|---|
| LDPE-Si-1 | /wt % | 98.0 | | 93.0 | | |
| LDPE-Si-2 | /wt % | | 98.0 | | 93.0 | |
| Plastomer | /wt % | | | | | 93.0 |
| Cat | /wt % | | | 5.0 | 5.0 | 5.0 |
| Talc-MB | /wt % | 2.0 | 2.0 | 2.0 | 2.0 | 2.0 |
| CO₂ | /wt % | 0.5 | 0.35 | 0.5 | 0.35 | 0.5 |
| Srew speed | /rpm | 10 | 25 | 10 | 20 | 7 |
| Mass flow | /kg/h | 4.3 | 6.3 | 4.3 | 5.2 | 1.7 |
| Gas amount | /ml/min | 0.47 | 0.52 | 0.48 | 0.39 | 0.13 |
| Gas pressure | /bar | 113 | 80 | 106 | 76 | 244 |
| Die insert | /mm | 2.5 | 2.5 | 2.5 | 2.5 | 4.0 |
| T1 | /° C. | 40 | 30 | 40 | 30 | 20 |
| T2 | /° C. | 140 | 120 | 140 | 120 | 50 |
| T3 | /° C. | 160 | 145 | 160 | 145 | 100 |
| T4 | /° C. | 170 | 155 | 170 | 155 | 125 |
| T5 | /° C. | 180 | 170 | 180 | 170 | 140 |
| T6 | /° C. | 190 | 180 | 190 | 180 | 150 |
| T7 | /° C. | 200 | 190 | 200 | 190 | 160 |
| T8 | /° C. | 200 | 190 | 200 | 190 | 160 |
| T9 | /° C. | 200 | 190 | 200 | 190 | 170 |
| T10 | /° C. | 200 | 190 | 200 | 190 | 170 |
| T11 | /° C. | 200 | 190 | 200 | 190 | 180 |
| T12 | /° C. | 200 | 190 | 200 | 190 | 180 |
| Die | /° C. | 200 | 190 | 200 | 190 | 190 |

The compositions of these comparative and inventive examples were prepared as follows.

A dry mixture of a polyethylene bearing hydrolysable silane groups, talc masterbatch, and silanol condensation catalyst was fed into Rosendahl RE45 (Rosendahl Maschinen GmbH, Austria) extruder equipped with 45 mm diameter screw. The extruder had a total length of 32 D, including 8 D long oil tempered cylinder elongation for polymer melt temperature control. A static mixer, type SMB-10 R (Sulzer, Switzerland) with a length of 4 D was mounted between the cylinder elongation and the extrusion die. Two different round die inserts were used having diameters of 2.5 and 4.0 mm. Carbon dioxide was added into the extruder once the mixture was completely molten.

Due to the different material behaviour and the resulting pressure profiles, it was necessary to variate the extrusion speed for the different formulations. In consideration of changing process parameters (pressure and mass flow) during the extrusion of different material formulations, the amount of CO₂ (in ml per minute) has to be adapted to ensure a constant and correct dosage of the blowing agent for all samples.

To guarantee constant parameters and reproducible samples the process has to run for a certain time until stationary conditions set in. Then the mass flow was determined, the required volume of CO₂ is calculated and set at the syringe pump. After stationary conditions have set in, again three samples for a later characterization of the foam morphology were taken.

Because of the very high pressures of the formulations based on the Queo polymer, the foaming was performed at very low mass flow rates using a larger round die.

TABLE 6
Properties of Foams

| | | CE5 | CE6 | IE6 | IE7 | CE7 |
|---|---|---|---|---|---|---|
| Mean cell size | /μm | 295 | 238 | 313 | 244 | 460 |
| Foam density | /kg/m³ | 252 | 370 | 217 | 384 | 768 |
| Density reduction | /% | 72.7 | 61.0 | 76.5 | 59.5 | 10.7 |
| Cell density | /Nb/cm³ | 53800 | 86500 | 47500 | 78400 | 2090 |
| XHU | /wt % | 0.07 | 0.28 | 97.12 | 97.48 | 98.66 |

As can be derived from Tables 5 and 6 above, the process according to the present invention enables producing crosslinked foams with high degree of crosslinking XHU in one step and without application of radiation or heat in an oven. Heat is merely applied in the extruder which is in any case required to melt and extrude the polyolefin composition. Less energy is consumed compared to prior art processes requiring an additional heat treatment. Further, the process according to the present invention does not require special production lines or equipment but relies on an extruder. The present invention provides a one-step process for preparing a crosslinked foam starting with a crosslinkable polyolefin composition.

1. A polyolefin composition comprising:
(A) a polyethylene bearing hydrolysable silane groups,
(B) a silanol condensation catalyst,
(C) a blowing agent, and
(D) a cell nucleating agent,
wherein the polyethylene bearing hydrolysable silane groups (A) is a copolymer of ethylene and a comonomer comprising a hydrolysable silane group and further comprises comonomer units comprising a polar group, wherein the comonomer units comprising a polar group are obtained from a comonomer selected from the group consisting of acrylic acid, methacrylic acid, acrylates, methacrylates, vinyl esters, and mixtures thereof, and
wherein the blowing agent (C) comprises a physical blowing agent or a mixture of physical blowing agents.

2. The polyolefin composition according to claim 1, wherein the comonomer comprising a hydrolysable silane group is represented by the following formula:
R¹SiR²_{q}Y_{3-q}
wherein R¹ is an ethylenically unsaturated hydrocarbyl, hydrocarbyloxy or (meth)acryloxy hydrocarbyl group,
each R² is independently an aliphatic saturated hydrocarbyl group,
Y, which may be the same or different, is a hydrolysable organic group, and
q is 0, 1 or 2.

3. The polyolefin composition according to claim 1, wherein the comonomer comprising a hydrolysable silane group is represented by the following formula:
CH₂═CHSi(OA)₃
wherein A is a hydrocarbyl group having 1 to 8 carbon atoms.

4. The polyolefin composition according to claim 1, wherein the silanol condensation catalyst (B) comprises an organic sulphonic acid or a precursor thereof including an acid anhydride thereof, or an organic sulphonic acid that has been provided with at least one hydrolysable protective group.

5. The polyolefin composition according to claim 1, wherein the content of the comonomer units comprising a polar group is 2.0 to 35.0 wt % based on the weight of the polyethylene bearing hydrolysable silane groups (A).

6. The polyolefin composition according to claim 1, wherein the content of the hydrolysable silane groups is 0.2 to 4.0 wt % based on the weight of the polyethylene bearing hydrolysable silane groups (A).

7. The polyolefin composition according to claim 1, wherein the amount of the polyethylene bearing hydrolysable silane groups (A) is 20.0 to 98.0 wt % based on the weight of the polyolefin composition.

8. The polyolefin composition according to claim 1, wherein the amount of the silanol condensation catalyst (B) is 1.0 to 9.0 wt % based on the weight of the polyethylene bearing hydrolysable silane groups (A).

9. The polyolefin composition according to claim 1, wherein the amount of the blowing agent (C) is 0.1 to 10 wt % based on the weight of the polyolefin composition.

10. The polyolefin composition according to claim 1, wherein the amount of the cell nucleating agent (D) is 0.1 to 5.0 wt % based on the weight of the polyolefin composition.

11. The polyolefin composition according to claim 1, wherein the cell nucleating agent (D) is a physical nucleating agent.

12. A crosslinked foam obtained from a polyolefin composition according to claim 1.

13. A process for producing a crosslinked foam comprising the following steps:
a) providing a polyolefin composition, wherein the polyolefin composition is as defined in claim 1,
b) extruding the polyolefin composition through a die of an extruder,
c) allowing the extruded polyolefin composition to expand at ambient conditions, and
d) allowing the extruded polyolefin composition to crosslink at ambient conditions.
